(19) United States
(12) Patent Application Publication
(10) Pub. No.: US 2025/0251657 A1
(43) Pub. Date: Aug. 7, 2025

(54) CAMERA MODULE

(71) Applicant: Japan Display Inc., Tokyo (JP)

(72) Inventors: Yoshiro AOKI, Tokyo (JP); Hirondo NAKATOGAWA, Tokyo (JP); Hitoshi TANAKA, Tokyo (JP)

(21) Appl. No.: 19/184,114

(22) Filed: Apr. 21, 2025

Related U.S. Application Data
(63) Continuation of application No. PCT/JP2023/034889, filed on Sep. 26, 2023.

(30) Foreign Application Priority Data
Oct. 27, 2022 (JP) 2022-172428

(51) Int. Cl. G03B 30/00; G01C 3/06; G02F 1/1335; H04N 23/55; H04N 23/57

(52) U.S. Cl. CPC G03B 30/00; G01C 3/06; G02F 1/133512; H04N 23/55; H04N 23/57

(57) ABSTRACT

According to one embodiment, a camera module includes an imaging device, a liquid crystal panel, a lens, and a controller. The liquid crystal panel includes an aperture pattern that allows light to be made incident on the imaging device, and includes a liquid crystal layer and a driver driving the liquid crystal layer to form the aperture pattern. The lens is located between the imaging device and the liquid crystal panel. The controller calculates a distance to a subject in an image, based on light that is transmitted through the aperture pattern of the liquid crystal panel and the lens and that is made incident on the imaging device. The liquid crystal panel is arranged to surround the lens.

### CROSS-REFERENCE TO RELATED APPLICATIONS

This application is a Continuation Application of PCT Application No. PCT/JP2023/034889, filed Sep. 26, 2023 and based upon and claiming the benefit of priority from Japanese Patent Application No. 2022-172428, filed Oct. 27, 2022, the entire contents of all of which are incorporated herein by reference.

### FIELD

Embodiments described herein relate generally to a camera module.

### BACKGROUND

In recent years, autonomous driving technology for automobiles has been attracting attention. In such autonomous driving technology, information on the ambient environment (for example, the shapes of objects located in the surrounding, the distances to the objects located in the surrounding, and the like) needs to be accurately understood. For this reason, the use of Laser Imaging Detection and Ranging (LiDAR) has been tentatively proposed as means for understanding information on the ambient environment.

However, there is a problem that LiDAR is expensive and mounting LiDAR on an automobile causes the price of the automobile to increase significantly. For this reason, means substituting for LiDAR is required as means for obtaining information on the ambient environment.

### BRIEF DESCRIPTION OF THE DRAWINGS

FIG. 1 is a perspective view showing a configuration example of a camera module according to an embodiment.

FIG. 2 is a cross-sectional view showing the configuration example of the camera module.

FIG. 3 is a plan view showing an example of an incident light control area.

FIG. 4 is a plan view showing another example of the incident light control area.

FIG. 5 is a view illustrating an overview of a camera module used to calculate a distance to a subject.

FIG. 6 is a view illustrating an overview of a camera module used to calculate a distance to a subject.

FIG. 7 is a view illustrating blur information added to an image captured by the camera module.

FIG. 8 is a view illustrating blur information added to an image captured by the camera module.

FIG. 9 is a view showing an example of installation of the camera module.

FIG. 10 is a diagram showing an example of the configuration of a distance measuring device according to a comparative example.

FIG. 11 is a cross-sectional view illustrating a positional relationship between a liquid crystal panel and a lens.

FIG. 12 is a perspective view showing a configuration example of a camera module according to a modified example.

FIG. 13 is a cross-sectional view showing the configuration example of the camera module according to the modified example.

### DETAILED DESCRIPTION

In general, according to one embodiment, a camera module comprises an imaging device, a liquid crystal panel, a lens, and a controller. The liquid crystal panel includes an aperture pattern that allows light to be made incident on the image sensor, and comprises a liquid crystal layer and a driver driving the liquid crystal layer to form the aperture pattern. The lens is located between the imaging device and the liquid crystal panel. The controller calculates a distance to a subject in an image based on the light that is transmitted through the aperture pattern of the liquid crystal panel and the lens and that is made incident on the imaging device. The liquid crystal panel is arranged to surround the lens.

According to another embodiment, a camera module comprises an imaging device, a liquid crystal panel, a lens, and a controller. The liquid crystal panel includes an aperture pattern that allows light to be made incident on the image sensor, and comprises a liquid crystal layer and a driver driving the liquid crystal layer to form the aperture pattern. The lens is located between the imaging device and the liquid crystal panel. The controller calculates a distance to a subject in an image based on the light that is transmitted through the aperture pattern of the liquid crystal panel and the lens and that is made incident on the imaging device. The liquid crystal panel is arranged to cover the lens along the surface of the lens.

Embodiments will be described hereinafter with reference to the accompanying drawings.

The disclosure is merely an example, and proper changes in keeping with the spirit of the invention, which are easily conceivable by a person of ordinary skill in the art, come within the scope of the invention as a matter of course. In addition, in some cases, in order to make the description clearer, the widths, thicknesses, shapes and the like, of the respective parts are illustrated schematically in the drawings, rather than as an accurate representation of what is implemented. However, such schematic illustration is merely exemplary, and in no way restricts the interpretation of the invention. In addition, in the specification and drawings, structural elements which function in the same or a similar manner to those described in connection with preceding drawings are denoted by like reference numbers, detailed description thereof being omitted unless necessary.

In the present embodiment, a camera module capable of calculating a distance from a camera to a subject in an image (hereinafter simply referred to as a distance to a subject) by using a subject image captured by the camera will be described.

For example, a coded aperture technique can be used as a technique for calculating the distance to the subject based on an image. Although its detailed description is omitted since this is a known technique, the coded aperture technique is a technique for calculating the distance to the subject by analyzing blur which occurs in an image depending on the position of the subject.

In other words, by using the above-described coded aperture technique, the distance to the subject can be calculated based on the image, and a depth map representing the distance to the subject can be created. Incidentally, the process of calculating the distance to the subject, the process of creating the depth map, and the like are executed by a controller (CPU) included in the camera module to control operations of the camera module.

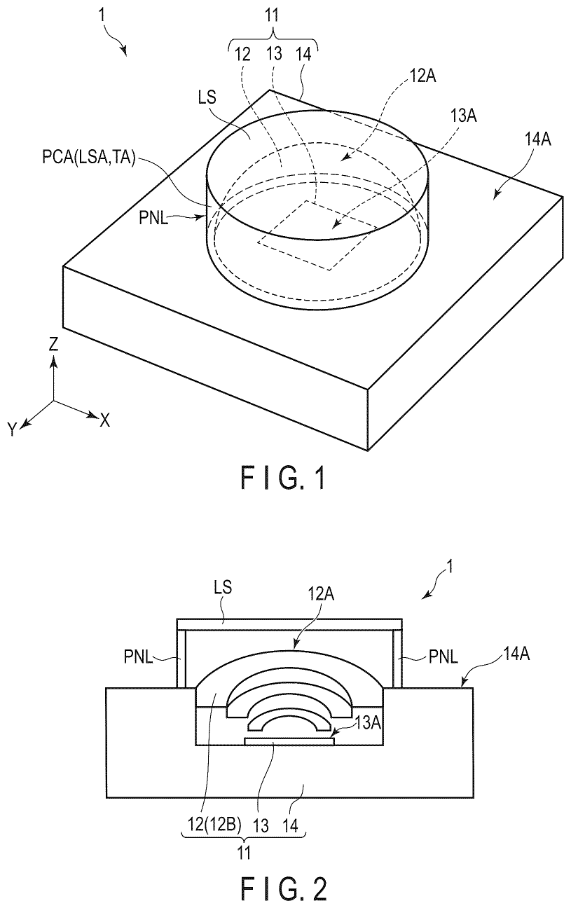

FIG. 1 is a perspective view showing a configuration example of a camera module 1 according to the present embodiment, and FIG. 2 is a cross-sectional view showing the configuration example of the camera module 1 according to the present embodiment. As shown in FIG. 1, the direction X, the direction Y, and the direction Z are orthogonal to each other, but may intersect at an angle other than 90 degrees.

As shown in FIG. 1 and FIG. 2, the camera module 1 comprises a camera 11 (for example, a spherical camera) and a liquid crystal panel PNL arranged to surround the camera 11. The liquid crystal panel PNL may be referred to as a liquid crystal shutter. Although its detailed description is omitted, the liquid crystal panel PNL comprises a first substrate (array substrate), a second substrate (counter-substrate) opposed to the first substrate, a liquid crystal layer arranged between the first substrate and the second substrate and sealed by a sealing material, and a driver which drives the liquid crystal layer. Incidentally, a color filter or backlight is not provided in the liquid crystal panel PNL since a visibly recognizable image does not need to be displayed.

The liquid crystal panel PNL has an aperture pattern including a large number of incident light control areas PCA. Although details are described later, the incident light control area PCA includes a light shielding area LSA located on at least the outermost periphery and having an annular shape, and a light transmissive area TA which is surrounded by the light shielding area LSA and which is in contact with the light shielding area LSA. In the liquid crystal panel PNL, the liquid crystal layer is driven by a driver, and the light transmissive area TA and the light shielding area LSA are thereby formed in each of the large number of incident light control areas PCA so as to form an aperture pattern. According to this, the liquid crystal panel PNL can function as a liquid crystal shutter comprising an incident light control function that controls the amount of light transmitted to the camera 11.

When a predetermined voltage is applied to the liquid crystal layer of the liquid crystal panel PNL and the liquid crystal layer is in an ON state (i.e., when the incident light control function is in an ON state), an aperture pattern including the light transmissive area TA is formed. According to this, since light transmitted through the light transmissive area TA can be made incident on the camera 11, the camera 11 can capture an image.

In contrast, when a predetermined voltage is not applied to the liquid crystal layer of the liquid crystal panel PNL and the liquid crystal layer is in an OFF state (i.e., when the incident light control function is in an OFF state), the light transmissive area TA is not formed and the aperture pattern is not formed either. In other words, the light to the camera 11 can be blocked.

Incidentally, in the present embodiment, it is assumed that the liquid crystal panel PNL is in a normally-black mode in which the liquid crystal layer transmits light, in the ON state, and blocks light, in the OFF state. However, the liquid crystal panel PNL may be in a normally-white mode in which the liquid crystal layer blocks light, in the ON state, and transmits light, in the OFF state.

As shown in FIG. 1 and FIG. 2, the camera 11 comprises an optical system 12 that includes at least one lens, an imaging device (image sensor) 13, and a casing (housing) 14.

The casing 14 accommodates the optical system 12 and the imaging device 13. The casing 14 has a main surface 14A, and the liquid crystal panel PNL is arranged on the main surface 14A so as to surround the optical system 12. The optical system 12 is located between the imaging device 13 and the liquid crystal panel PNL. The optical system 12 has a light entrance surface 12A, and the light entrance surface 12A does not overlap with the liquid crystal panel PNL in plan view. The imaging device 13 has an imaging surface 13A, and the imaging surface 13A overlaps with the light entrance surface 12A of the optical system 12 in plan view. In other words, the imaging surface 13A of the imaging device 13 does not overlap with the liquid crystal panel PNL in plan view either.

The imaging device 13 of the camera 11 receives light through the liquid crystal panel PNL and the optical system 12. The imaging device 13 is configured to convert the incident light transmitted through the aperture pattern formed on the liquid crystal panel PNL, and the optical system 12, into images (data). Incidentally, the camera 11 (imaging device 13) is configured to convert, for example, visible light (for example, light in the wavelength range of 400 nm to 700 nm) transmitted through the liquid crystal panel PNL and the optical system 12 into images, but may be further configured to convert infrared light (for example, light in the wavelength range of 800 nm to 1500 nm) into images.

A light shielding portion LS is arranged on the liquid crystal panel PNL. The light shielding portion LS overlaps with and faces the light entrance surface 12A of the optical system 12 and the imaging surface 13A of the imaging sensor 13 in plan view. The light shielding portion LS blocks light from a direction orthogonal to the light entrance surface 12A and the imaging surface 13A.

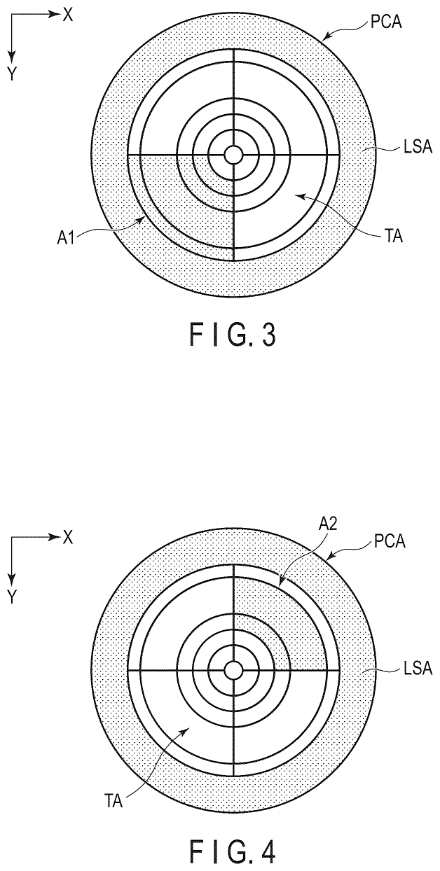

FIG. 3 and FIG. 4 are plan views showing examples of the incident light control area PCA of the liquid crystal panel PNL. In the example shown in FIG. 3, a first area A1 of the incident light control area PCA is set to a non-transmissive state, and areas of the incident light control area PCA other than the light shielding area LSA and the first area A1 are set to a transmissive state (i.e., the light transmissive area TA). In contrast, in the example shown in FIG. 4, a second area A2 of the incident light control area PCA is set to a non-transmissive state, and areas of the incident light control area PCA other than the light shielding area LSA and the second area A2 are set to a transmissive state (i.e., the light transmissive area TA).

An aperture pattern including a large number of incident light control areas PCA as shown in FIG. 3 and FIG. 4 is formed on the liquid crystal panel PNL. According to this, since light transmitted through the aperture pattern formed on the liquid crystal panel PNL is made incident on the imaging device 13, blur information can be added to the captured images.

Incidentally, in the present embodiment, it has been described that the incident light control area PCA has a circular shape. However, the shape of the incident light control area PCA is not limited to this, but may be a shape other than the circular shape (for example, a rectangular shape or the like). In addition, in the present embodiment, examples of the incident light control area PCA are shown in FIG. 3 and FIG. 4. However, the incident light control area PCA is not limited to these. Which area of the incident light control area PCA is set to a transmissive state and which area is set to a non-transmissive state (i.e., which area of the incident light control area PCA excluding the light blocking area LSA is set to the light transmissive area TA) may be set and changed appropriately depending on the capturing scene.

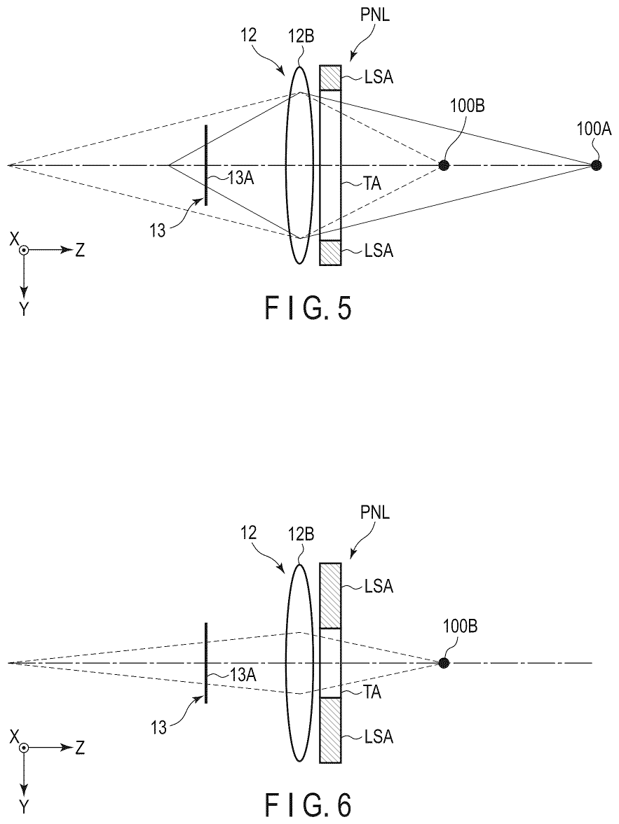

An overview of the camera module 1 used to calculate the above-described distance to the subject will be hereinafter described with reference to FIG. 5 and FIG. 6. Incidentally, as described above, the camera module 1 in the present embodiment is assumed to comprise the camera 11 (the optical system 12 including the lens and the imaging device 3) for capturing the subject, and the liquid crystal panel PNL for controlling the light made incident on the camera 11. In addition, the lens 12B included in the optical system 12 is assumed to be a lens capable of including a wide range in its capturing range or desirably a lens capable of including 360 degrees in the horizontal direction in its capturing range, for example, a fisheye lens or the like.

FIG. 5 shows a positional relationship between the camera module 1 and a subject 100A. In FIG. 5, calculating the distance from the camera 11 (camera module 1) to the subject 100A located at a relatively remote position is assumed. In the camera 11, for example, the subject 100A can be captured in a state in which the subject 100A is focused by changing the distance between the lens 12B included in the optical system 12 and the imaging device 13. As shown in FIG. 5, however, when the subject 100A is captured in a state in which the subject 100A is out of focus, an image based on the light made incident on the imaging device 13 is blurred since the focal position and the position of the imaging surface 13A of the imaging device 13 are displaced.

As shown in FIG. 5, the aperture pattern including the incident light control area PCA including the light transmissive area TA and the light shielding area LSA can add blur information to images and, according to the above-described coded aperture technique, the distance to the subject 100A can be calculated based on the blur that occurs in the images.

Next, calculating the distance from the camera 11 (camera module 1) to a subject 100B located at a relatively close position is assumed. When calculating the distance to the subject 100B, the subject 100B is captured in a state in which the subject 100B is out of focus. As shown in FIG. 5, however, when the distance from the camera 11 to the subject 100B is short, part of the light transmitted through the aperture pattern formed on the liquid crystal panel PNL and the lens 12B is not made incident on the imaging device 13. In this case, it is considered that even if the distance from the image to the subject 100B, which is based on the light made incident on the imaging device 13, is calculated, the light that is not made incident on the imaging device 13 (blur information) cannot be used to calculate the distance to the subject 100B and an error therefore occurs in the distance (i.e., the accuracy of the distance becomes low).

In this case, as shown in FIG. 6, all of the light transmitted through the light transmissive area TA and the lens 12B can be made incident on the imaging device 13 by reducing the size of the light transmissive area TA (size of the aperture pattern). According to this, the accuracy in the distance to the subject 100B can be improved as compared to the case in which the size of the light transmissive area TA shown in FIG. 5 as described above is large.

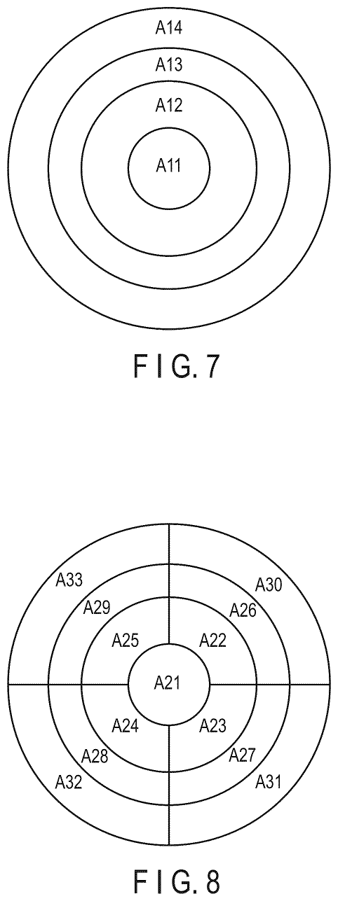

FIG. 7 is a view illustrating blur information added to an image captured by the camera module 1 according to the present embodiment. As described above, since the camera module 1 according to the present embodiment comprises the fisheye lens that can include 360 degrees in the horizontal direction to its capturing range, the image captured by the camera module 1 is a circular omnidirectional image, as shown in FIG. 8. Blur information based on Point Spread Function (PSF) that is set according to the aperture pattern is added to the image captured by the camera module 1. According to this, the distance to the subject in the image can be calculated by the above-described coded aperture technique.

However, a fisheye lens has different thicknesses at the center and the end portions of the lens. Even if a uniform PSF is set for all areas of the circular omnidirectional image and blur information is added uniformly to the omnidirectional image, it is considered that the distance to the subject in the omnidirectional image cannot be calculated with high accuracy. For this reason, in the camera module 1 according to the present embodiment, the capturing range (omnidirectional image) is divided into a plurality of concentric areas A11 to A14 and the aperture pattern of the liquid crystal panel PNL is changed for each of the areas A11 to A14, thereby enabling PSF to be set for each of the areas A11 to A14, and blur information different for each of the areas A11 to A14 is added, thereby enabling the distance to the subject to be calculated with high accuracy.

The example of dividing the omnidirectional image into the plurality of concentric areas A11 to A14 is shown in FIG. 7. However, the form of dividing the omnidirectional image into a plurality of areas is not limited to the form shown in FIG. 7. For example, as shown in FIG. 8, the omnidirectional image may be divided more finely, the aperture pattern of the liquid crystal panel PNL may be changed for each of areas A21 to A33, and different PSF may be set for each of the areas A21 to A33.

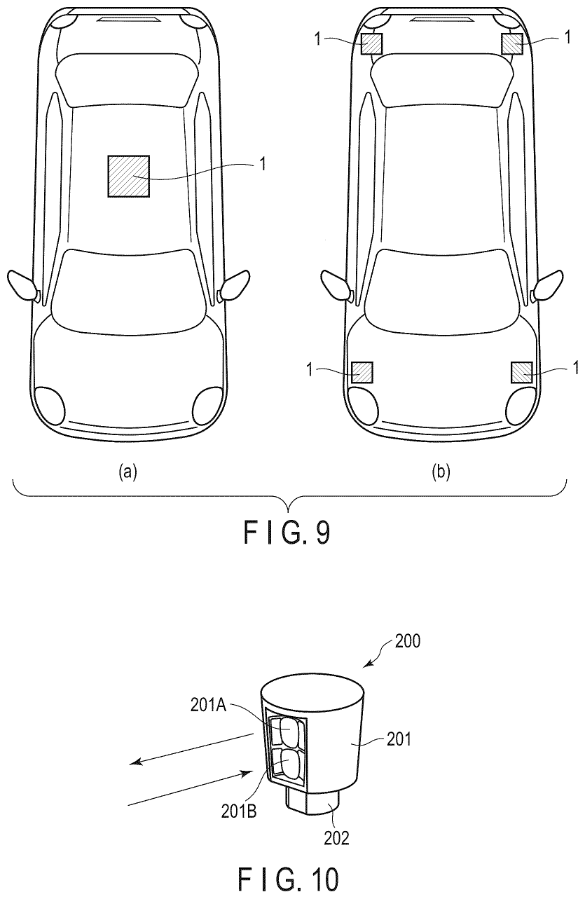

FIG. 9 is a view showing an installation example of the camera module 1 according to the present embodiment. As shown in FIG. 9(a), the camera module 1 is installed on, for example, a roof of a vehicle. The camera module 1 captures images of a subject at 360 degrees in the horizontal direction, and calculates the distance to the subject based on the captured images. Alternatively, as shown in FIG. 9(b), the camera modules 1 may be installed in a total of four locations, for example, near the front light and the rear light of the vehicle, the subject may be captured at 360 degrees in the horizontal direction by four camera modules 1, and the distance to the subject may be calculated. Incidentally, it has been described that the vehicle is an automobile. However, the vehicle is not limited to this, but may be a motorcycle, a drone, or the like.

Advantages of the camera module 1 according to the present embodiment will be described with reference to a comparative example. Incidentally, the comparative example is intended to describe a part of the advantages that can be achieved by the camera module 1 according to the present embodiment and do not exclude advantages common to the comparative example and the present embodiment from the scope of the present invention.

FIG. 10 is a diagram showing a configuration example of a distance measuring device 200 according to a comparative example. The distance measuring device 200 according to the comparative example comprises a distance measuring unit 201 referred to as Laser Imaging Detection and Ranging (LiDAR) and a rotation mechanism 202 for rotating the distance measuring unit 201. As shown in FIG. 10, the distance measuring unit 201 includes a laser emitting unit 201A that emits laser light and a laser receiving unit 201B that receives the laser light reflected by an object. The distance measuring unit 201 measures the time in which the laser light emitted from the laser emitting unit 201A is reflected by the object and received by the laser receiving unit 201B, and measures the distance to the object and the direction. Since the laser emitting unit 201A included in the distance measuring unit 201 can only emit laser light in one direction, the distance measuring device 200 is provided with the rotation mechanism 202 for rotating the distance measuring unit 201. According to this, the laser emitting unit 201A included in the distance measuring unit 201 can emit laser light over the range in which the rotation mechanism 202 can rotate (i.e., can emit laser light in a plurality of directions), and can perform the above-described measurement over the range.

As described above, the distance measuring device 200 according to the comparative example requires the rotation mechanism 202 for rotating the distance measuring unit 201. In general, however, there is a problem that a movable unit such as the rotation mechanism 202 is likely to be damaged and the device including the movable unit lacks reliability as a device. In addition, there is another problem that the LiDAR 201 constituting the distance measuring device 200 according to the comparative example is very expensive and the vehicle models in which the distance measuring device 200 can be installed are limited to high-end models (models with high vehicle prices).

In contrast, since the camera module 1 according to the present embodiment does not require providing the rotation mechanism 202 as provided in the comparative example, the camera module 1 is unlikely to be damaged and can increase the reliability of the above-described device. In addition, since the camera module 1 according to the present embodiment does not require expensive components such as the laser emitting unit 201A and the laser receiving unit 201B included in the LiDAR 201 constituting the distance measuring device 200 according to the comparative example, the camera module 1 can be produced at a low price, and can be mounted on not only the above-described high-end models, but also on a wide variety of vehicles.

In addition to the distance measuring device 200 according to the comparative example, there is a distance measuring device that uses two cameras (stereo cameras) to measure the distance to an object. However, the camera module 1 according to this embodiment only needs to be equipped with one camera 11, so it is possible to reduce the number of parts compared to the distance measuring device using the stereo camera described above.

As described above, in the configuration according to the present embodiment, the camera module 1 comprises the liquid crystal panel PNL arranged to surround the optical system 12. The liquid crystal panel PNL has the aperture pattern formed by driving the liquid crystal layer with a driver, and comprises the incident light control function of controlling the amount of light transmitted to the camera 11 (optical system 12 and imaging device 13). The optical system 12 includes a lens that can include 360 degrees in the horizontal direction in the capturing range, for example, a fisheye lens or the like.

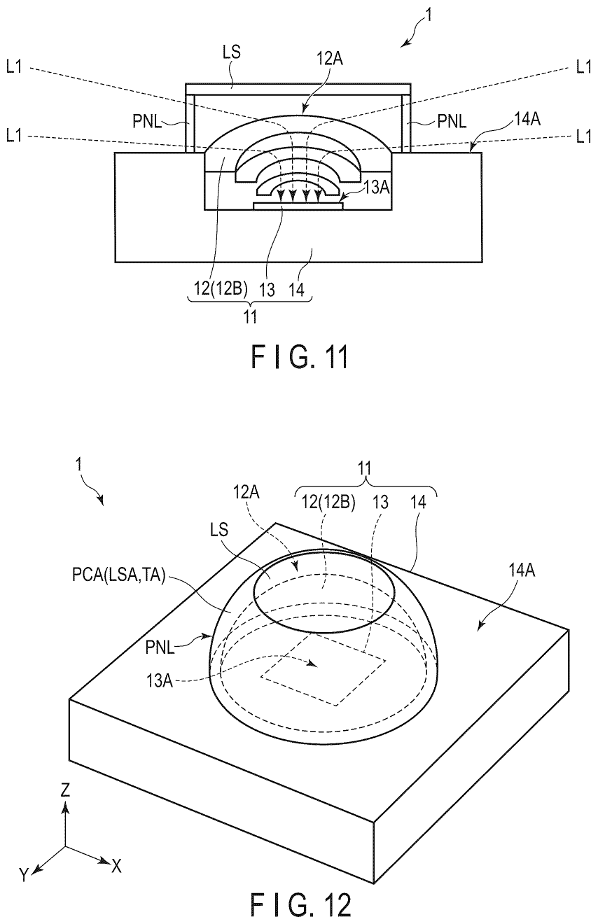

According to this, as shown in FIG. 11, the camera module 1 allows light L1 transmitted through the aperture pattern formed on the liquid crystal panel PNL to be made incident on the optical system 12 and the imaging device 13, and can capture an image of 360 degrees in the horizontal direction based on the light L1 at once. Since the blur information based on the PSF that is set according to the aperture pattern formed on the liquid crystal panel PNL is added to the captured image, the camera module 1 can calculate the distance to the subject included in the image, using the above-described coded aperture technique.

In addition, the above-described camera module 1 comprises the light shielding portion LS provided at a position which overlaps with the light entrance surface 12A of the optical system 12 and the imaging surface 13A of the imaging device 13 in plan view. According to this, since light from a direction orthogonal to the light entrance surface 12A and the imaging surface 13A can be blocked, the subject located above the camera module 1 is not captured in the image, and the distance to the subject located above the camera module 1 does not need to be calculated. In other words, the amount of calculations in the CPU of the camera module 1 can be reduced, and the processing load on the CPU can be reduced.

Incidentally, if it is desired to calculate the distance to the subject located above the camera module 1, a liquid crystal panel comprising a function similar to that of the above-described liquid crystal panel PNL may be arranged instead of the above-described light shielding portion LS. In this case, it is possible to calculate the distance to the subject located above the camera module 1, in addition to the distance to the subject located across 360 degrees in the horizontal direction of the camera module 1.

In the present embodiment, it has been described that the liquid crystal panel PNL is arranged in a cylindrical shape so as to surround the optical system 12. However, the liquid crystal panel PNL is not limited to this, but may be arranged in a prismatic shape so as to surround the optical system 12. Even in this case, the same advantages as described above can be obtained since the liquid crystal panel PNL is arranged so as to surround the optical system 12, since the liquid crystal panel PNL comprises the incident light control function, and since the optical system 12 includes a lens that can include 360 degrees in the horizontal direction in the capturing range.

In the present embodiment, it has been described that the liquid crystal panel PNL is arranged so as to surround the optical system 12. However, since the lens 12B included in the optical system 12 is curved as shown in FIG. 11, the distance between the liquid crystal panel PNL and the lens 12B is not constant. For this reason, the light transmitted through the portion where the liquid crystal panel PNL and the lens 12B are separated is more likely to be focused on the liquid crystal panel PNL than the light transmitted through other portions (i.e., portions where the liquid crystal panel PNL and the lens 12B are not separated). According to this, the aperture pattern formed on the liquid crystal panel PNL may be reflected as noise, in an image based on the light transmitted through the portion where the liquid crystal panel PNL and the lens 12B are separated.

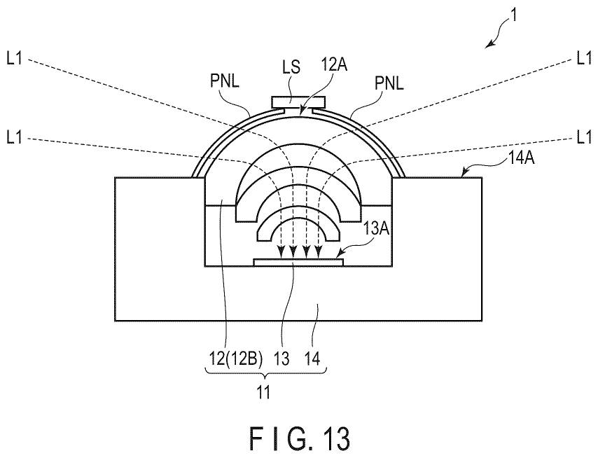

For this reason, the liquid crystal panel PNL may be arranged so as to cover the lens 12B along the surface of the lens 12B included in the optical system 12, as shown in FIG. 12 and FIG. 13. In this configuration, the liquid crystal panel PNL overlaps with the light entrance surface 12A of the optical system 12 and the imaging surface 13A of the imaging device 13 in plan view, as shown in FIG. 12 and FIG. 13. According to this configuration, since the distance between the liquid crystal panel PNL and the lens 12B can be made constant, it is possible to prevent the aperture pattern formed on the liquid crystal panel PNL from appearing as noise in the image, and it is possible to calculate the distance to the subject with higher accuracy.

In the above-described present embodiment, it has been described that a single liquid crystal panel PNL is arranged to surround the optical system 12 or to cover the lens 12B along the surface of the lens 12B of the optical system 12. However, the embodiment is not limited to this, but a plurality of liquid crystal panels may be divided and arranged in the surrounding of the optical system 12. Even in this case, since a plurality of liquid crystal panels are arranged to surround the optical system 12 or to cover the lens 12B along the surface of the lens 12B of the optical system 12, the same advantages as described above can be obtained.

According to the above-described embodiment, the camera module 1 capable of recognizing information on the ambient environment (distance to the subject) can be provided.

All of the display devices that can be implemented by a person of ordinary skill in the art through arbitrary design changes to the camera module described above as embodiments of the present invention come within the scope of the present invention as long as they are in keeping with the spirit of the present invention.

Various types of the modified examples are easily conceivable within the category of the ideas of the present invention by a person of ordinary skill in the art and the modified examples are also considered to fall within the scope of the present invention. For example, additions, deletions or changes in design of the constituent elements or additions, omissions, or changes in condition of the processes arbitrarily conducted by a person of ordinary skill in the art, in the above embodiments, fall within the scope of the present invention as long as they are in keeping with the spirit of the present invention.

In addition, the other advantages of the aspects described above in the embodiments, which are obvious from the descriptions of the present specification or which can be arbitrarily conceived by a person of ordinary skill in the art, are considered to be achievable by the present invention as a matter of course.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A camera module comprising:
an imaging device;
a liquid crystal panel including an aperture pattern that allows light to be made incident on the imaging device, and comprising a liquid crystal layer and a driver driving the liquid crystal layer to form the aperture pattern;
a lens located between the imaging device and the liquid crystal panel; and
a controller calculating a distance to a subject in an image, based on light that is transmitted through the aperture pattern of the liquid crystal panel and the lens and that is made incident on the imaging device, wherein
the liquid crystal panel is arranged to surround the lens.

2. The camera module of claim 1, wherein
the lens includes 360 degrees in a horizontal direction in a capturing range.

3. The camera module of claim 1, wherein
the liquid crystal panel does not overlap with the lens and the imaging device in plan view.

4. The camera module of claim 1, further comprising:
a light shielding portion arranged on the liquid crystal panel to overlap with the lens and the imaging device in plan view.

5. A camera module comprising:
an imaging device;
a liquid crystal panel including an aperture pattern that allows light to be made incident on the imaging device, and comprising a liquid crystal layer and a driver driving the liquid crystal layer to form the aperture pattern;
a lens located between the imaging device and the liquid crystal panel; and
a controller calculating a distance to a subject in an image, based on light that is transmitted through the aperture pattern of the liquid crystal panel and the lens and that is made incident on the imaging device, wherein
the liquid crystal panel is arranged to cover the lens along a surface of the lens.

6. The camera module of claim 5, wherein the lens includes 360 degrees in a horizontal direction in a capturing range.

7. The camera module of claim 5, wherein the liquid crystal panel overlaps with the lens and the imaging device in plan view.

8. The camera module of claim 5, further comprising:
a light shielding portion arranged on the liquid crystal panel to overlap with the lens and the imaging device in plan view.
